(19) United States
(12) Patent Application Publication
(10) Pub. No.: US 2008/0022308 A1
(43) Pub. Date: Jan. 24, 2008

(54) Pre-populated Search Results In Electronic Program Guide Data

(75) Inventor: Federico Garcea, Sunnyvale, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/459,304

(22) Filed: Jul. 21, 2006

(51) Int. Cl. G06F 13/00; H04N 5/445; G06F 3/00

(52) U.S. Cl. 725/46; 725/39

(57) ABSTRACT

Pre-populated search results in electronic program guide (EPG) data is described. In an embodiment, EPG data includes asset information which corresponds to a media content asset where a value is associated with a descriptor category to describe the media content asset, and a tag is associated with the value to pre-populate a search result by identifying related media content assets which are related to the value. The EPG data that includes the asset information can be communicated to a television-based client device to pre-populate the search result such that, upon receiving a viewer-initiated search request at the television-based client device to identify related media content assets associated with the value, a display of the related media content assets associated with the value and identified by the tag can be generated from the EPG data at the television-based client device.

### BACKGROUND

During the past several years, television viewing habits have been rapidly changing in response to advances in technology, and to increased availability of viewing content. Many people now use electronic program guides to locate programs and/or other media content assets. An electronic program guide (EPG) is an on-screen interactive guide that allows a viewer to navigate among and select media content assets which may be available for viewing and/or recording.

Current electronic program guides are typically displayed as a grid which lists the programs that are available during selected time periods. In some cases, the EPG will also allow the viewer to search the programs by channel, to schedule certain reminders, to request video on demand (VOD) assets, and/or to set parental control functions. The grid which lists the programs may also provide a brief description of one or more of the programs. For example, the brief description for a particular program or media content asset may list the program title, the plot description, the name of the lead actor, the name of the director, the name of the producer, the program rating, the program category, and/or other characteristics of that particular media content asset.

In some cases, after viewing the brief description of a program via the on-screen interactive guide, the viewer may want to locate other media content assets which are in some way related to the program outlined in the brief description. For example, the viewer may want to locate other movies by the same director. In such a case, the viewer can select the director's name via the on-screen interactive guide to initiate a server request to search for other movies by the same director. In response to receiving the viewer's selection, the server request is initiated at the viewer's client device (e.g., the viewer's set-top box or other device), and the server request is then communicated to a remote server which is generally located at a content provider. The process of generating the server request, communicating the server request from the client device to the remote server, processing the server request to generate a server response, and communicating the server response from the remote server back to the client device all take time, and the viewer must wait for an extended time period to receive and view the results of such a search.

### SUMMARY

This summary is provided to introduce simplified concepts of pre-populated search results in EPG data which is further described below in the Detailed Description. This summary is not intended to identify essential features of the claimed subject matter, nor is it intended for use in determining the scope of the claimed subject matter.

In an embodiment, EPG data includes asset information which corresponds to a media content asset where a value is associated with a descriptor category to describe the media content asset, and a tag is associated with the value to pre-populate a search result by identifying related media content assets which are related to the value. The EPG data that includes the asset information can be communicated to a television-based client device to pre-populate the search result such that, upon receiving a viewer-initiated search request at the television-based client device to identify related media content assets associated with the value, a display of the related media content assets associated with the value and identified by the tag can be generated from the EPG data at the television-based client device.

### BRIEF DESCRIPTION OF THE DRAWINGS

The same numbers are used throughout the drawings to reference like features and components:

FIG. 1 illustrates an exemplary television-based system in which embodiments of pre-populated search results in EPG data can be implemented.

FIG. 2 illustrates an exemplary television-based system in which further aspects of embodiments of pre-populated search results in EPG data are described.

FIG. 3 illustrates an exemplary scenario in which further aspects of embodiments of pre-populated search results in EPG data are described.

FIG. 4 illustrates an exemplary scenario in which further aspects of embodiments of pre-populated search results in EPG data are described.

FIG. 5 illustrates exemplary method(s) for pre-populated search results in EPG data.

FIG. 6 illustrates exemplary method(s) for pre-populated search results in EPG data.

FIG. 7 illustrates an exemplary IP-based television (IPTV) system in which embodiments of pre-populated search results in EPG data can be implemented.

FIG. 8 illustrates various components of an exemplary client device in which embodiments of pre-populated search results in EPG data can be implemented.

FIG. 9 illustrates various devices and components in an exemplary entertainment and information system in which embodiments of pre-populated search results in EPG data can be implemented.

### DETAILED DESCRIPTION

Pre-populated search results in EPG data is described in which embodiments provide that asset information can be associated with a media content asset, such as a television-based program, in EPG data which can then be communicated to a television-based client device. The asset information can include a value that is associated with a descriptor category to describe the media content asset, and a tag that is associated with the value to pre-populate a search result by identifying related media content assets which are related to the value. For example, the EPG data for a particular movie can include a descriptor category, such as “Director”, and a value that is associated with the descriptor category, such as “Ron Howard”. A tag that is then associated with the value identifies related media content assets, such as other movies directed by “Ron Howard”.

The EPG data that includes the asset information can be communicated to the television-based client device to pre-populate a search result such that, upon receiving a viewer-initiated search request at the television-based client device to identify the related media content assets associated with the value, a display of the related media content assets associated with the value and identified by the tag can be generated from the EPG data at the television-based client device. The display of the related media content assets can be generated at the television-based client device without initiating a request to an EPG server to identify and/or provide a list of the related media content assets.

While aspects of the described systems and methods for pre-populated search results in EPG data can be implemented in any number of different computing systems, environments, television-based entertainment systems, and/or configurations, embodiments of pre-populated search results in EPG data are described in the context of the following exemplary systems and environments.

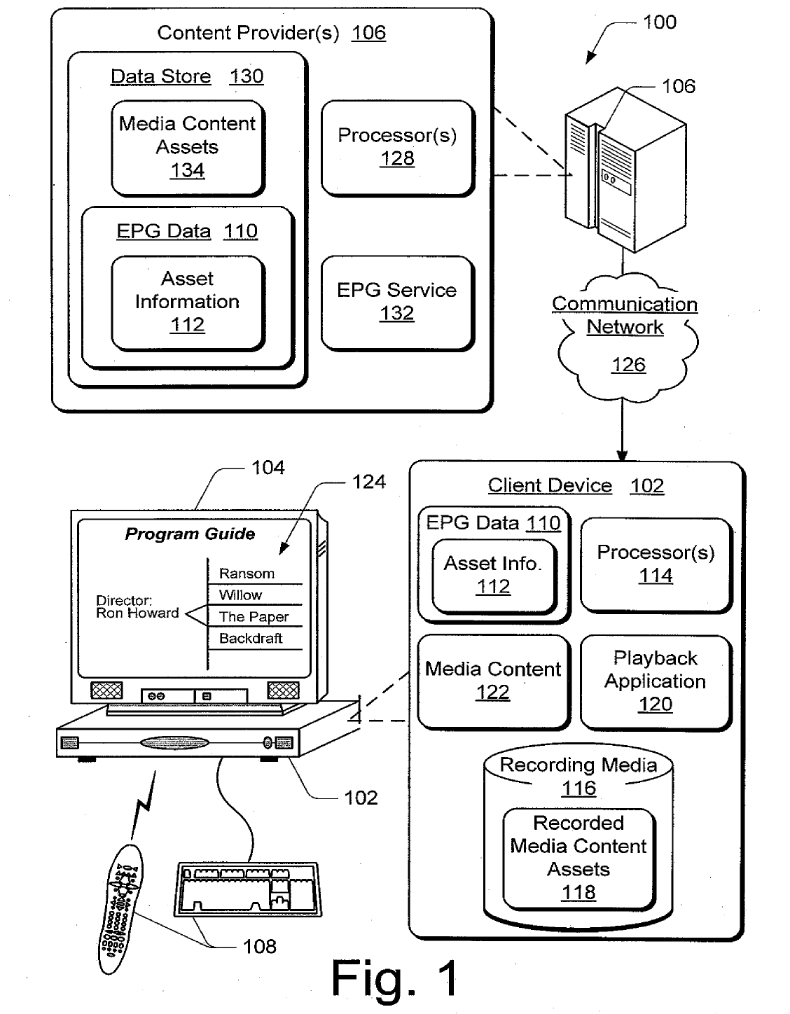

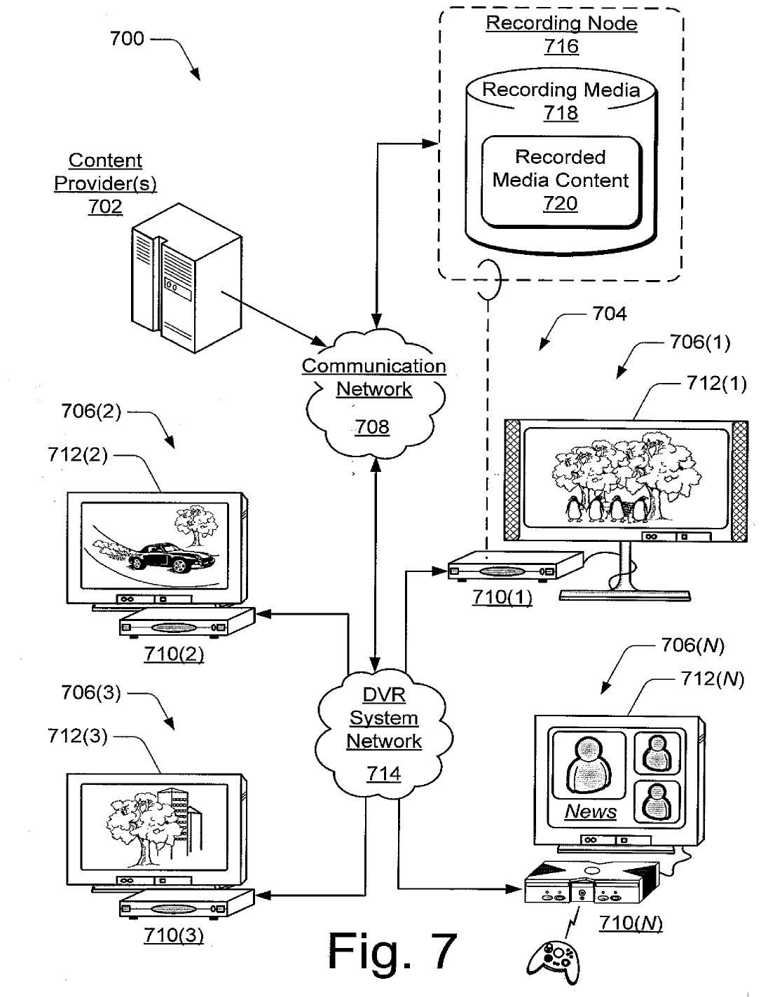

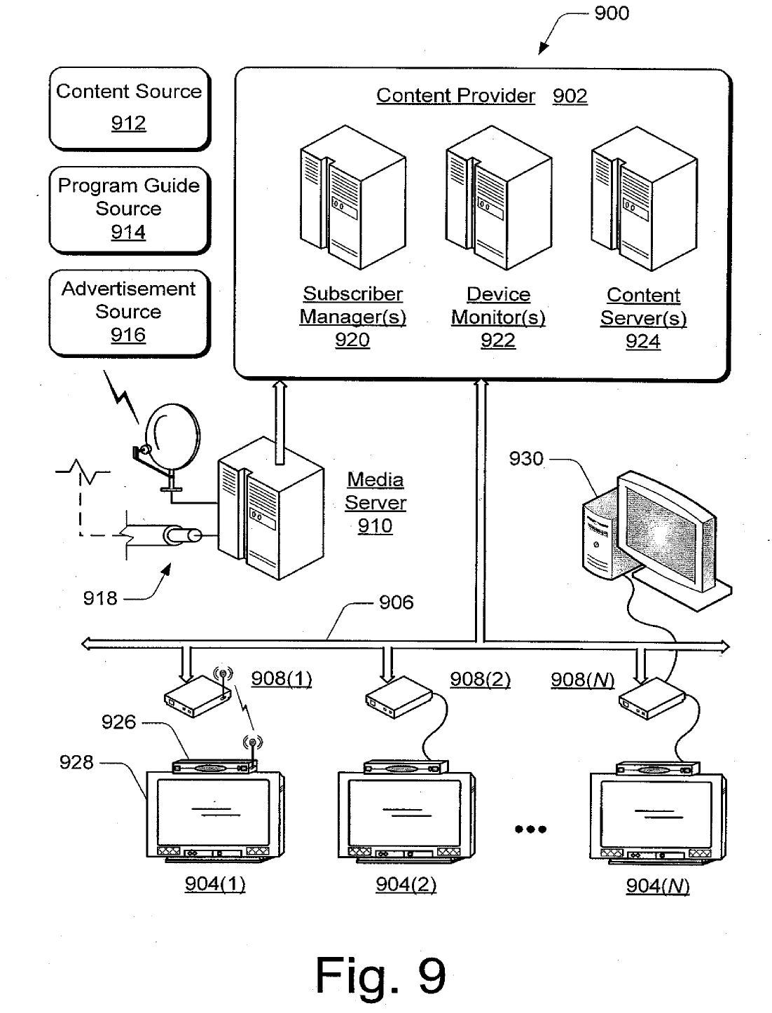

FIG. 1 illustrates an exemplary system 100 in which embodiments of pre-populated search results in EPG data can be implemented. The system 100 includes a television-based client device 102, a display device 104, content provider(s) or server(s) 106, and input devices 108, such as a remote control device and a computer keyboard. The display device 104 can be any type of television, LCD, or similar television-based display system that renders audio, video, and/or image data. The client device 102 and display device 104 together are but one example of a television-based client system, examples of which are described with reference to the exemplary IP-based television (IPTV) system 700 shown in FIG. 7, and with reference to the exemplary entertainment and information system 900 shown in FIG. 9.

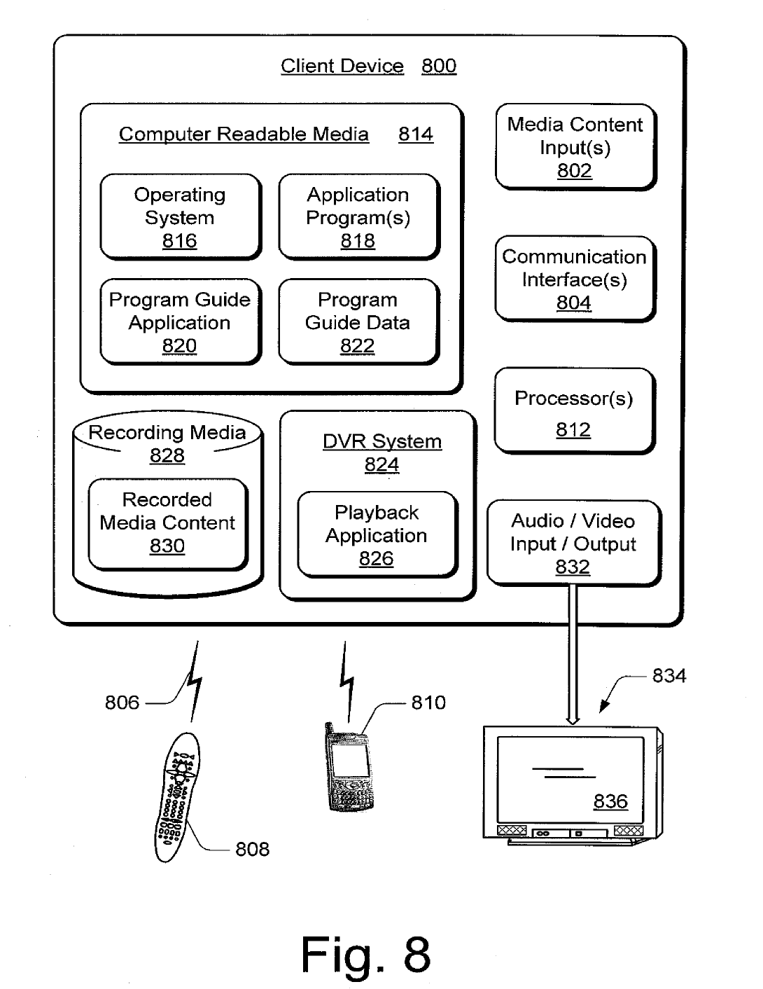

Client device 102 can be implemented in any number of embodiments, such as a set-top box, a digital video recorder (DVR) and playback system, an appliance device, a gaming device, and as any other type of client device that may be implemented in a television-based entertainment and information system. In this example, client device 102 includes EPG data 110 which includes asset information 112 that identifies related media content assets which are identified by a tag and associated with a value that describes a media content asset. The EPG data 110 which includes the asset information 112 are received from the content provider(s) 106. The client device 102 also includes one or more processor(s) 114, recording media 116 that maintains recorded media content assets 118, and a playback application 120 which can be implemented as computer executable instructions and executed by the processor(s) 114 to implement embodiments of pre-populated search results in EPG data. Additionally, client device 102 may be implemented with any number and combination of differing components as further described below with reference to the exemplary client device 800 shown in FIG. 8.

Recording media 116 along with the playback application 120 can be implemented as a DVR system to record and maintain the recorded media content assets 118 which may be any form of on-demand and/or broadcast media content 122 such as programs, movies, commercials, music, and similar audio, video, and/or image content that client device 102 receives and/or records. Further, client device 102 may access or receive additional recorded media content that is maintained with a remote data store located at content provider 106. Still further client device 102 may access or receive additional recorded media content that is maintained with a video-on-demand server or media content that is maintained at a broadcast center or content provider that distributes the media content to subscriber sites and client devices.

The playback application 120 is a video control application that, in this example, can be implemented to control the playback of media content 122, the recorded media content assets 118, and or other video on-demand media content, music, and any other audio, video, and/or image media content which can be rendered and/or displayed for viewing on display device 104, such as a program guide 124 which can be in interactive on-screen program guide. In the illustrated example, the program guide 124 displays a list of media content assets (e.g., movies which are directed by a particular movie director—“Ron Howard”) for a viewer who is using the television-based client device 102.

The television-based client device 102 is configured for communication with the content provider(s) or server(s) 106 via a communication network 126, which in this example, is an IP-based network. The client device 102 receives programs, associated program content, various forms of media content, program guide data, advertising content, and other media content from the content provider(s) 106 via the IP-based network 126.

The content provider 106 includes one or more processor(s) 128, a data store 130, and an electronic program guide service 132 which can be implemented as computer executable instructions and executed by the processor(s) 128 to implement embodiments of pre-populated search results in EPG data. The data store can store media content assets 134 which can be communicated to the client device 102. The content provider 106 also includes the EPG data 110 which can be communicated from the content provider 106 to the client device 102 via the communication network 126. The content provider 106 may also include additional EPG data which is not communicated to the client device 102. The EPG data 110 which is communicated to the client device 102 includes the asset information 112. The EPG data 110 is communicated from the content provider 106 to the client device 102 where the EPG data 110 can be made available to a viewer via the interactive on-screen program guide 124.

Although the media content assets 134 and the EPG data 110 are each illustrated and described as being stored in a single data store 130, each of the media content assets 134 and the EPG data 110 can be stored in various formats and/or distributed among various data stores. Further, although the EPG service 132 is illustrated and described as a single application program, the EPG service 132 can be implemented as several component applications distributed to perform one or more of the functions described in various embodiments of pre-populated search results in EPG data. In one embodiment, the EPG service 132 of the content provider 106 is configured to associate the asset information 112 with a media content asset 134 in the EPG data 110 which is communicated to the television-based client device 102.

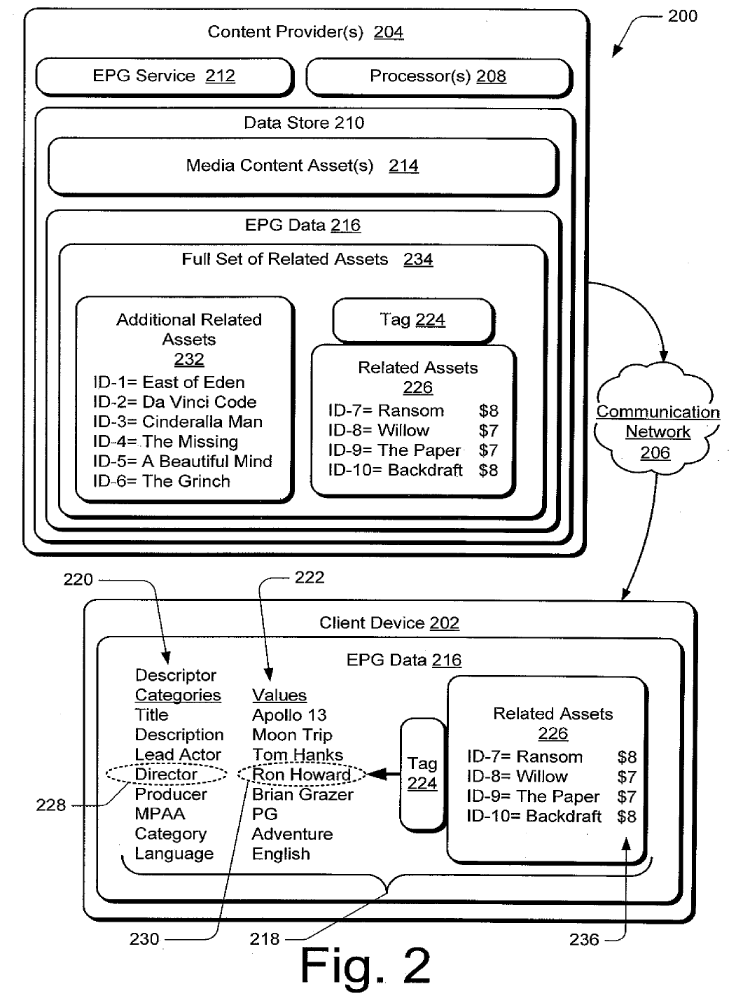

FIG. 2 illustrates an exemplary television-based system in which further aspects of embodiments of pre-populated search results in EPG data are described. The system 200 includes a television-based client device 202 and content provider(s) 204. The television-based client device 202 is configured for communication with the content provider 204 via an IP-based communication network 206. The system 200 can also include a display device and input devices such as those described with reference to FIG. 1 (not shown in FIG. 2). The television-based client device 202 can include any of the components and/or modules described with reference to client device 102 of FIG. 1, and the content provider(s) 204 can include any of the components and/or modules described with reference to content provider(s) 106 of FIG. 1.

As illustrated, the content provider 204 includes one or more processor(s) 208, a data store 210, and an electronic program guide (EPG) service 212 which can be implemented as computer executable instructions and executed by the processor(s) 208 to implement embodiments of pre-populated search results in EPG data. The data store 210 can store media content assets 214 and EPG data 216, both of which can be communicated from the content provider 204 to the client device 202 via communication network 206.

Embodiments of pre-populated search results in EPG data provide that asset information 218 is associated with a media content asset 214 in the EPG data 216 at the content provider or server 204, and the EPG data 216 can then be communicated to a television-based client device 202. Because the EPG data 216 is generated at the content provider 204 and communicated to the client device 202, the EPG data 216 which is present at the client device 202 can also be present at the content provider 204. However, for clarity, the details of the EPG data 216 are initially described herein with reference to client device 202. The EPG data 216 at client device 202 can include one or more descriptor categories 220, and one or more values 222 which describe the media content asset 214 are associated with the descriptor categories 220. In addition, at least one of the values 222 included in the EPG data 216 is associated with a tag 224 which identifies a list of related media content assets 226 which are associated with the value which has been tagged.

In the illustrated example of FIG. 2, the asset information 218 has been associated with a particular media content asset 214 (e.g., a movie entitled “Apollo 13”) at the server 204 as part of the EPG data 216. The EPG data 216 associated with the media content asset 214 is then communicated from the server 204 to the television-based client device 202. Therefore, the EPG data 216 received by the television-based client device 202 includes the descriptor categories 220 which are associated with values 222 that describe the movie “Apollo 13”.

For example, the descriptor categories 220 include one descriptor category entitled “Director” which is indicated by reference number 228. The descriptor category entitled “Director” 228 is associated a value “Ron Howard” as indicated by reference number 230. Therefore, for the movie “Apollo 13”, the descriptor category-value combination (i.e., 228, 230) indicates that the movie's director is “Ron Howard”. By way of further example, the full-list of descriptor category-value combinations include: “Title Apollo 13”, “Description=Moon Trip”, “Lead Actor=Tom Hanks”, “Director=Ron Howard”, “Producer=Brian Grazer”, “MPAA (Rating)=PG”, “Category Adventure”, and “Language=English”. These descriptor categories 220 are provided by way of example only, as other descriptor categories can easily be implemented.

As described herein, at least one of the values 222 included in the EPG data 216 received by the television-based client device 202 is tagged with an associated tag 224 which identifies a list of related media content assets 226 which are associated with the value. In the illustrated example, the value 230 (e.g., the value “Ron Howard”) is tagged with the associated tag 224. The tag 224 identifies a list of related media content assets 226 which are associated with the value 230 (e.g., the value “Ron Howard”) which has been tagged. Here the list of related media content assets 226 identified by the tag 224 is a list of movies which were directed by “Ron Howard”. Each movie in the list can be identified by an associated ID number, for example: “ID-7=Ransom”; “ID-8=Willow”; “ID-9=The Paper”; and “ID-10=Backdraft”. The list of related media content assets 226 which are associated with the value 230 can include any number of related media content assets that have been selected for inclusion in the list. However, the list of related media content assets 226 will not typically include all of the related media content assets associated with the value 230 which may be available at the server 204. Therefore, additional related media content assets 232 may be available at the content provider 204.

As described herein, the server 204 includes the one or more processor(s) 208, the data store 210, and the electronic program guide (EPG) service 212 which can be implemented as computer executable instructions and executed by the processor(s) 208 to implement embodiments of pre-populated search results in EPG data. The data store 210 can store media content assets 214 which can be communicated to the client device 202 via communication network 206, and can also store EPG data 216. The EPG data 216 can be communicated from the content provider 204 to the client device 202 via the communication network 206. However, the content provider and can also maintain additional EPG data which is not communicated to the client device 202.

Although the EPG data 216 can include large amounts of metadata related to various media content assets 214, for clarity the illustration of FIG. 2 focuses on EPG data which is associated with a single value 230 (e.g., the value “Ron Howard”). In the present example, the value 230 “Ron Howard” is associated with the descriptor category 228 “Director”, and the related media content assets of interest are those assets directed by “Ron Howard”.

In FIG. 2, the content provider 204 maintains full set of related assets for the value “Ron Howard” as indicated by reference number 234. The full set of related media content assets 234 for the value “Ron Howard” includes a list of movies which were directed by “Ron Howard” (in addition to the currently selected movie) and which are included in the data Store 210. Each movie included in the full set of related assets 234 can be identified by an associated ID number, for example: “ID-1=East of Eden”; “ID-2=The Da Vinci Code”; “ID-3=Cinderella Man”; “ID-4=The Missing”; and “ID-5=A Beautiful Mind” “ID-6=The Grinch”; “ID-7=Ransom”; “ID-8=Willow”; “ID-9=The Paper”; and “ID-10=Backdraft”. The full set of related assets 234 listed here by way of example only, as “Ron Howard” has directed other movies in addition to those listed, however these other movies have been omitted from this example for the sake of clarity.

The list of related assets for the value “Ron Howard” which are identified by the tag 224 is indicated by reference number 226. The list of related assets 226 for the value “Ron Howard” is also a list of movies which were directed by “Ron Howard”. The list of related assets 226 for the value “Ron Howard” is a list of movies which have been selected from the full set of related assets 234, for association with and identification by the tag 224. Each movie included in list of related assets 226 can be identified by an associated ID number, for example: “ID-7=Ransom”; “ID-8=Willow”; “ID-9=The Paper”; and “ID-10=Backdraft”. The list of related media content assets 226 which are associated with the value (e.g. value “Ron Howard” 230) can include any number of related media content assets which have been selected to be identified by the tag 224. However, the list of related media content assets 226 does not typically include all of the items which are included in the full set of related media content assets 234. Therefore, additional related media content assets 232 may be listed and available at the content provider 204.

In one embodiment, server 204 can be configured to specify which of the items listed in the full set of related assets 234 are to be included in the list of related assets 226. The server 204 can also be configured to specify which of the values 222 is to receive the tag 224. The list of related media content assets 226 can be associated with the value 230 based on many different criteria. For example, the list of related media content assets 226 can be associated with the value 230 based on viewer recommendations, based on viewer requests, based on associated fees, and/or based on a language which is associated with the related media content asset.

In some embodiments, the tag 224 can also identify additional data 236 which is associated with the related media content assets 226. For example, in the present example, the tag 224 includes additional data 236 which identifies fees associated with selecting and viewing the related media content assets 226. In some implementations, the additional data 236 can initially be hidden from view, and then later be displayed in response to receiving a user selection of one of the related media content assets 226 for viewing.

In some implementations, the list of related media content assets 226 which are associated with the value 230 include video on demand (VOD) assets, and the tag 224 identifies additional data 236 associated with the VOD assets. For example, the fees associated with selecting and viewing the VOD assets can initially be hidden from view, and the additional data can be displayed in response to receiving a user selection of a VOD asset from the list of related media content assets 226.

With this background in mind, one can appreciate that when a viewer selects the tagged value 230 (e.g., “Ron Howard”) via the EPG display (e.g., via program guide 124 of FIG. 1) a viewer-initiated search request to identify related media content assets 226 which are associated with the value 230 (e.g., movies directed by “Ron Howard”) is initiated at the client device 202. In response to this viewer-initiated search request, a display of a list of related media content assets 226 identified by the tag 224 can be quickly generated and displayed to the viewer. The display of the list of related media content assets 226 can be generated without initiating and/or sending a request to the content provider 204 to identify and/or provide the list of related media content assets 226.

In addition, while the viewer is examining the list of related media content assets 226 which have been quickly displayed, a server request to provide additional related media content assets 232 which are related to the value 230 can take place in the background, so that a server response providing the additional related media content assets 232 can be received at the television-based client device 202 and the results available for display by the time the viewer has examined the list of related media content assets 226. For example, in one embodiment, once the server 204 determines that the full set of related media content assets 234 includes additional related media content assets 232 which are not included in the list of related media assets 226, a display of the additional related media content assets 232 is generated. When a viewer-initiated search request is made, the flexible approach described herein can quickly provide the viewer with an initial search result 226 (i.e., the EPG at the client device 202 can display the list of related assets 226 identified by the tag 224) without waiting for a response from the remote server/content provider 204. In addition, because a server request to identify the additional related media content assets 232 can take place in the background while the initial search result (i.e., the list of related assets 226) is displayed, the viewer can be quickly presented with an apparently seamless and comprehensive search result.

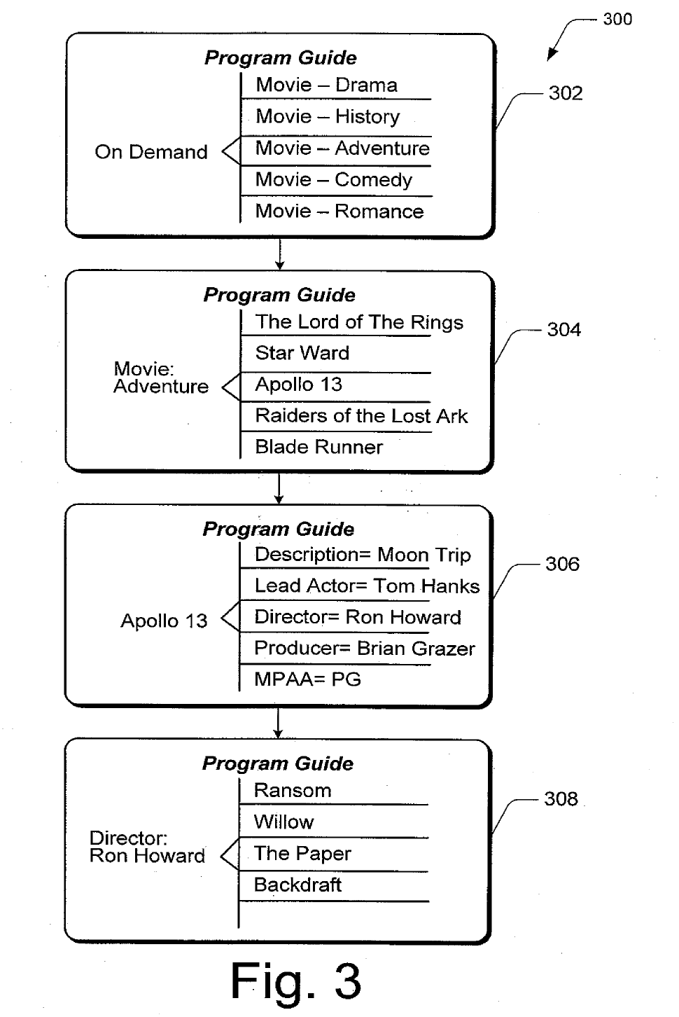

FIG. 3 illustrates an exemplary scenario 300 in which further aspects of embodiments of pre-populated search results in EPG data are described with ongoing reference to FIGS. 1 and 2. Exemplary scenario 300 is described in the context of a series of program guide displays for navigating to and/or selecting video on demand (VOD) assets. For each of the illustrated programs guide displays, the viewer can scroll up or scroll down the displayed lists using an input device (e.g., such as the remote control device and/or computer keyboard 108 of FIG. 1) to view additional results and/or make selections.

Once a viewer has selected to search VOD assets, a program guide display 302 lists different movie categories for which VOD assets are available (e.g., “Movie-Drama”, “Movie-History”, “Movie-Adventure”, “Movie-Comedy”, and “Movie-Romance”). In the present example, at program guide display 302 the viewer selects to view VOD assets from the category “Movie-Adventure” and is then presented with program guide display 304 by the client device 202 without initiating a server request.

At program guide display 304 the viewer is presented with a list of VOD assets which are available under the selected category “Movie-Adventure” (e.g., “The Lord of the Rings”, “Star Wars”, “Apollo 13”, “Raiders of the Lost Ark”, and “Blade Runner”). At program guide display 304, if the viewer selects the movie “Apollo 13”, the viewer is presented with program guide display 306 by the client device 202 without initiating a server request.

At program guide display 306 the viewer is presented with a list of descriptor categories and associated values which describe the selected movie “Apollo 13” (e.g., “Description Moon Trip”, “Lead Actor=Tom Hanks”, “Director=Ron Howard”, “Producer Brian Grazer”, and “MPAA=PG”). At program guide display 306, if the viewer selects the value “Ron Howard” which is associated with the descriptor category “director”, the viewer is then presented with program guide display 308 by the client device 202 without initiating a server request.

At program guide display 308 the viewer is quickly presented with a list of VOD assets which are associated with the selected value “Ron Howard” (e.g., “The Missing”, “Ransom”, “The Paper”, and “Backdraft”). The list of VOD assets represents a list of related assets 226 which are identified by the tag 224 which is associated with the value “Ron Howard”. This list of related media content assets 226 identified by the tag 224 can be generated from the EPG data 216 at the television-based client device 202. Therefore, the related media content assets 226 can be displayed without initiating a request to the content provider 204 to provide the related media content assets 226.

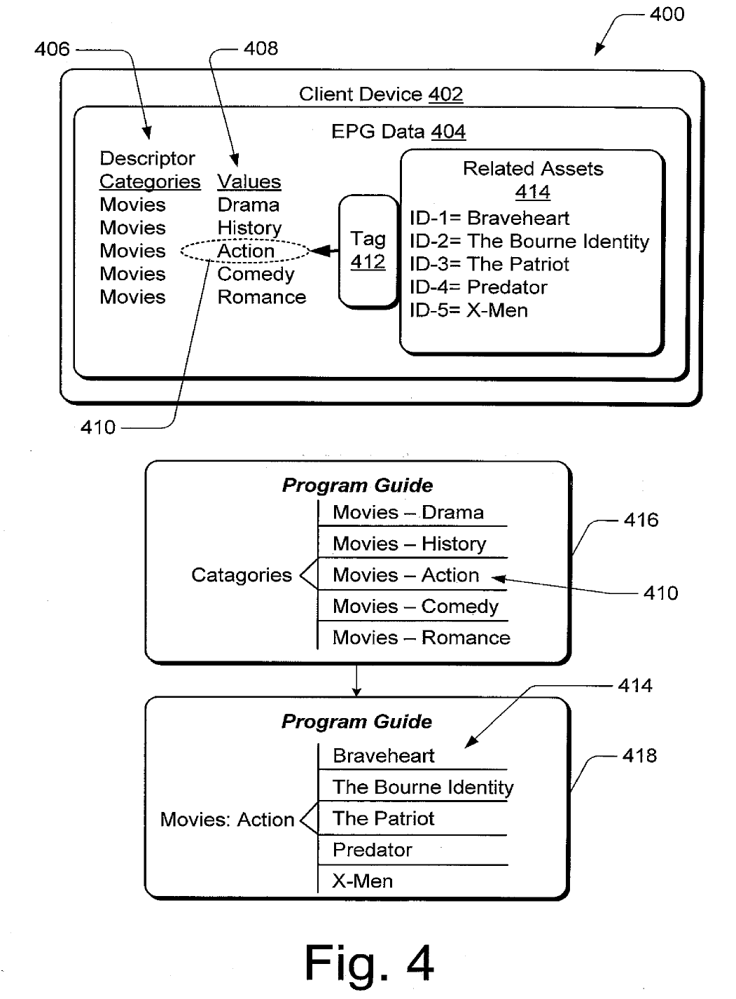

FIG. 4 illustrates an exemplary scenario 400 in which further aspects of embodiments of pre-populated search results in EPG data are described. The exemplary scenario 400 describes implementing embodiments of pre-populated search results in EPG data to search for movies of a particular category or genre. The illustration includes a television-based client device 402. Although the television-based client device 402 can include any of the components and/or modules which were described with reference to client device 102 and 202 of respective FIGS. 1 and 2, and can be configured for communication with content provider(s) via an IP-based communication network as described with reference to FIGS. 1 and 2, for the sake of clarity many such elements have been omitted from the illustration of FIG. 4.

Instead, the exemplary scenario 400 focuses on the client device 402 which has received EPG data 404 from a content provider (not shown). The EPG data 404 can include one or more descriptor categories 406, and one or more values 408 which describe media content assets which are associated with the descriptor categories 406. In addition, at least one of the values 408 included in the EPG data 404 is associated with a tag 412 which identifies a list of related media content assets 414 which are associated with the value 410 which has been tagged.

In the illustrated example, the value 410 (e.g., the value “Action”) has been tagged with the associated tag 412. The tag 412 identifies the list of related media content assets 414 which are associated with the value 410 (e.g., the value “Action”) which has been tagged. Here the list of related media content assets 414 identified by the tag 412 is a list of “Action” movies. Each movie in the list can be identified by an associated ID number, for example: “ID-1=Braveheart”; “ID 2=The Bourne Identity”; “ID-3=The Patriot”; “ID-4=Predator”; and “ID-5=X-Men”.

A viewer at client device 402 can be presented with an EPG display 416 which lists the values 408 which can be selected. If the viewer selects the value “Action” 410 from the EPG display 416, a viewer-initiated search request to identify related media content assets (i.e., “Action-Movies”) which are associated with the value 410 is received at the client device 402.

As illustrated by EPG display 418, a display of the list of related media content assets 414 identified by the tag 412 can be generated in response to the viewer-initiated search request, without initiating a server request to identify the set of related media content assets 414 (i.e., “Action-Movies”). As described herein, while the viewer is examining the list of related media content assets 414 which can be quickly displayed without the server request, a server request to identify additional related media content assets (i.e., “Action-Movies”) which are available from the server (not shown), can take place in the background.

One can appreciate that because various metadata at the server can be associated with values, and the values can be associated with tags which identify media content assets which are respectively associated with the values, many types of EPG data can be pre-populated with search results. Therefore, pre-populated search results in EPG data provides very flexible and convenient techniques for communicating pre-populated search results in the EPG data to a television-based client device. The pre-populated search results can be quickly displayed in response to a viewer-initiated search request without waiting for a server request and/or server response.

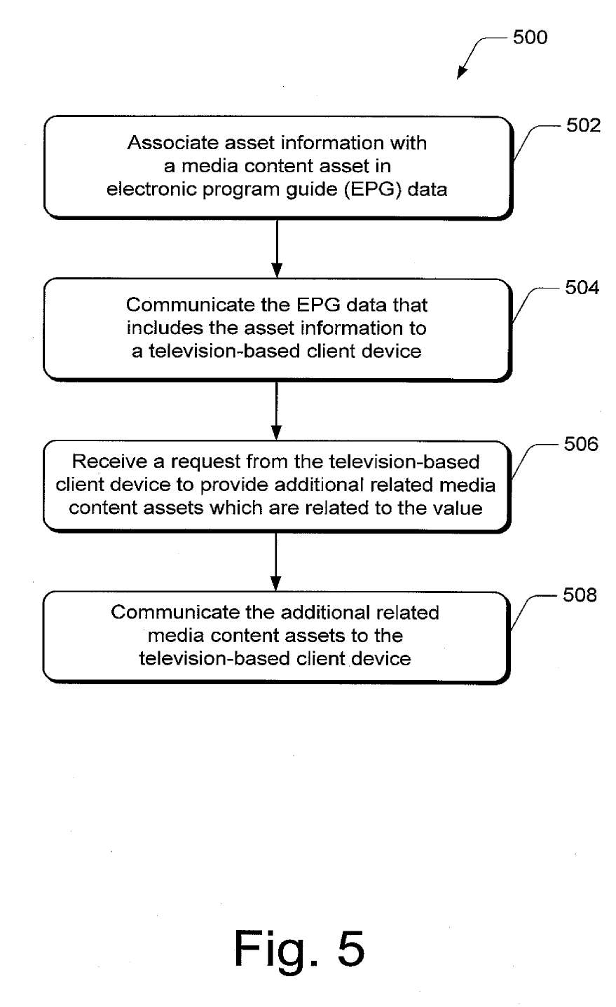

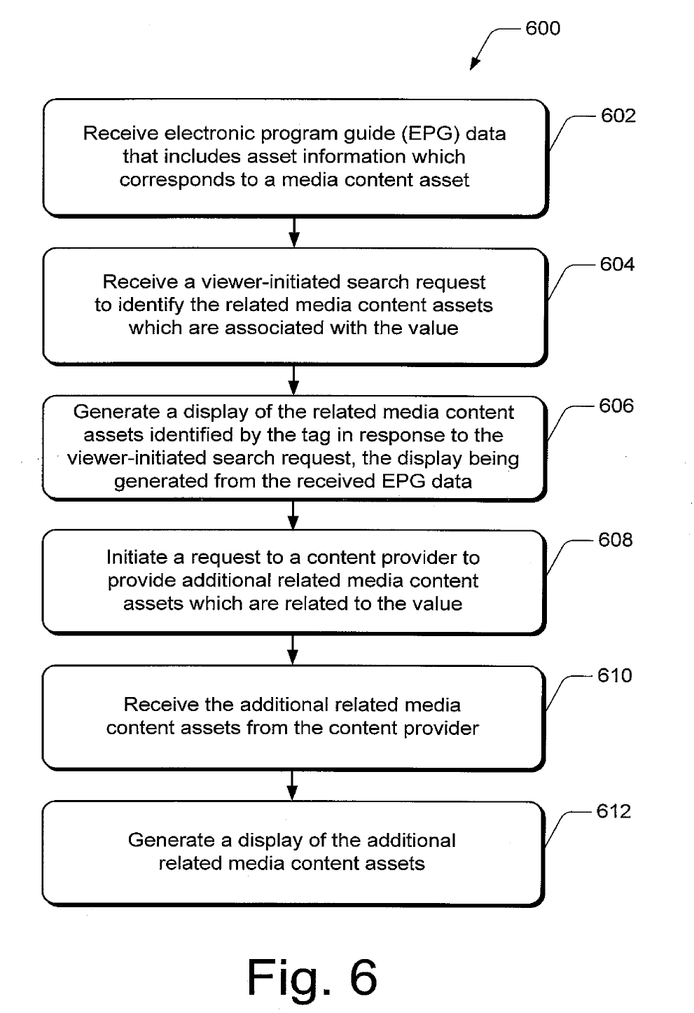

Methods for pre-populated search results in EPG data, such as exemplary methods 500 and 600 described with reference to respective FIGS. 5 and 6, may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 5 illustrates an exemplary method 500 for pre-populated search results in EPG data and is described with reference to the exemplary system 100 shown in FIG. 1 and the exemplary system 200 shown in FIG. 2. The order in which the method is described is not intended to be construed as a limitation, and any number of the described method blocks can be combined in any order to implement the method, or an alternate method. Furthermore, the method can be implemented in any suitable hardware, software, firmware, or combination thereof.

At block 502, asset information is associated with a media content asset in electronic program guide (EPG) data which can be communicated to a television-based client device. As part of this process, a value is associated with a descriptor category to describe the media content asset, and a tag is associated with the value to pre-populate a search result by identifying related media content assets which are related to the value. For example, the value 230 (e.g., “Ron Howard”) which describes the media content asset 214 (e.g., the movie—“Apollo 13”) is associated with the descriptor category 228 (e.g., “Director”), and the tag 224 is associated with the value 230 (e.g., “Ron Howard”) to pre-populate a search result by identifying a list of related media content assets 226 which are associated with the value 230 (e.g., “Ron Howard”). The list of related media content assets 226 identified by the tag 224 can be for example, a list of movies which were directed by “Ron Howard”, and each movie in the list can be identified by an associated ID number, for example: “ID-7=Ransom”; “ID-8=Willow”; “ID-9=The Paper”; and “ID-10=Backdraft”.

At block 504, the EPG data that includes the asset information is communicated to the television-based client device. The television-based client device can receive a viewer-initiated search request to identify the related media content assets which are associated with the value by the tag, and generate a display of the related media content assets from the EPG data in response to the viewer initiated search request. For example, the EPG data 210 that includes the asset information 218 is communicated from the content provider 204 to the television-based client device 202. The television-based client device 202 can receive a viewer-initiated search request to identify the related media content assets 226 which are associated with the value 230 (e.g., “Ron Howard”) by the tag 224, and generate a display 124 of the related media content assets 226 from the EPG data 216 in response to the viewer initiated search request.

At block 506, a request is received from the television based client device to provide additional related media content assets which are related to the value. For example, a request can received from the television based client device 202 to provide additional related media content assets 232 which are related to the value 230 (e.g., “Ron Howard”).

At block 508, the additional related media content assets are communicated to the television based client device. For example, the additional related media content assets 232 can be communicated to the television based client device 202 in response to the request.

FIG. 6 illustrates an exemplary method 600 for pre-populated search results in EPG data and is described with reference to the exemplary system 100 shown in FIG. 1, the exemplary system 200 shown in FIG. 2, and with reference to the exemplary scenario 300 shown in FIG. 3. The order in which the method is described is not intended to be construed as a limitation, and any number of the described method blocks can be combined in any order to implement the method, or an alternate method. Furthermore, the method can be implemented in any suitable hardware, software, firmware, or combination thereof.

At block 602, electronic program guide (EPG) data that includes asset information which corresponds to a media content asset is received. The asset information includes descriptor categories, and a value is associated with at least one of the descriptor categories to describe the media content asset. A tag identifies related media content assets which are associated with the value. For example, the EPG data 216 that includes the asset information 218 which corresponds to a media content asset 214 is received at the client device 202. The asset information 218 includes descriptor categories 220, a value 230 (e.g., “Ron Howard”) describing the media content asset 214 (e.g., the movie—“Apollo 13”) is associated with at least one of the descriptor categories 228 (e.g., “Director”), and a tag 224 is associated with the value 230 (e.g., “Ron Howard”). The tag 224 identifies a list of related media content assets 226 which are associated with the value 230. For example, the list of related media content assets 226 identified by the tag 224 can be a list of movies which were directed by “Ron Howard”, and each movie in the list can be identified by an associated ID number, for example: “ID-7=Ransom”; “ID-8=Willow”; “ID-9=The Paper”; and “ID-10=Backdraft”.

At block 604, a viewer-initiated search request to identify the related media content assets which are associated with the value is received. For example, a viewer-initiated search request to identify related media content assets 226 which are associated with the value 230 (e.g., “Ron Howard”) can be received at the client device 202.

At block 606, a display of the related media content assets identified by the tag is generated in response to the viewer-initiated search request. The display of the related media content assets is generated from the received EPG data. For example, a display of the list of related media content assets 226 identified by the tag 224 is generated from the received EPG data 216.

At block 608, a request to a content provider to provide additional related media content assets which are related to the value is initiated. For example, a request to the content provider 204 to provide additional related media content assets 232 which are related to the value 230 (e.g., “Ron Howard”) can be initiated at the television-based client device 202.

At block 610, the additional related media content assets are received from the content provider. For example, the television-based client device 202 can receive the additional related media content assets 232 from the content provider 204.

At block 612, a display of the additional related media content assets is generated. For example, a display of the additional related media content assets 232 can be generated at the television-based client device 202.

FIG. 7 illustrates an exemplary IP-based television (IPTV) environment 700 in which embodiments of pre-populated search results in EPG data can be implemented. The IPTV environment 700 includes content provider(s) 702 and a multi-DVR system 704 that can include any number of television-based client systems 706(1−N). The multi-DVR system 704 can represent a household viewing system that has several viewing areas, such as different rooms, for viewing television programs. The multi-DVR system 704 is configured for communication with any number of the different content provider(s) 702 via a communication network 708 which, in this example, is an IP-based network. Any of the systems and/or devices can be configured for network access in any number of embodiments and varieties of implementation.

The television-based client systems 706(1−N) of the multi-DVR system 704 are representative of DVR nodes in a multi-DVR system. Each of the DVR nodes of the multi-DVR system 704 can communicate with each other to act and make decisions on behalf of the other nodes, for the overall common good of the multi-DVR system 704, and based on the state of individual nodes and/or based on the state of the multi-DVR system 704.

The television-based client system 706(1) includes a television-based client device 710(1) and a display device 712(1), such as any type of television, monitor, LCD, or similar television-based display system that together renders audio, video, and/or image data. Similarly, the television-based client systems 706(2−N) each include a respective television-based client device 710(2−N) and a respective display device 712(2−N). Each television-based client device 710 can be implemented in any number of embodiments, such as a television-based set-top box, a digital video recorder (DVR) and playback system, an appliance device, a gaming system such as client device 710(N), and as any other type of client device that may be implemented in a television-based entertainment and information system.

The television-based client devices 710(1−N) of the television-based client systems 706(1−N) can be implemented for communication with each other via a DVR system network 714, and may be implemented with any number and combination of differing components as further described below with reference to the exemplary client device shown in FIG. 8. Further, the IPTV environment 700 may be implemented with any number and combination of differing components as described below with reference to the exemplary entertainment and information system shown in FIG. 9.

A television-based client system 706 at a node of the multi-DVR system 704 can receive programs, associated program content, various forms of media content, program guide data, advertising content, and other types of media content from content server(s) of the content provider(s) 702 via the communication network 708. Media content can include television-based programs (or programming) which may be any form of programs, commercials, music, movies, and video on-demand movies. Other media content can include recorded media content, interactive games, network-based applications, and any other similar audio, video, and/or image content. In addition, media content in general may include music streamed from a computing device to a client device, such as a television-based set-top box, and may also include video on-demand media content delivered from a server, a photo slideshow, and any other audio, video, and/or image content received from any type of media content source.

Although the data streams are not shown specifically, the arrowed communication links illustrate various data communication links which include the data streams. Additionally, the arrowed communication links are not intended to be interpreted as a one-way communication link from the DVR system network 714 to a client device 710(1), for example. It is contemplated that any one or more of the arrowed communication links can facilitate two-way data communication, such as from communication network 708 to a content provider 702.

The multi-DVR system 704 includes a recording node 716 which includes a recording media 718 to maintain recorded media 720. In an embodiment, any one or more of the television-based client devices 710(1−N) in the multi-DVR system 704 can be implemented as the recording node 716 (as shown by the dashed line) which includes the recording media 718 to record media content received from a content provider 702. Alternatively (or in addition), a recording node of the multi-DVR system 704 can be implemented as a network-based recording node that the multi-DVR system 704 can communicate with via the communication network 708. In another implementation, the recording node 716 can be an independent component of the multi-DVR system 704.

The recording node 716 can record media content with the recording media 718 for any one or more of the television-based client devices 710(1−N) of the multi-DVR system 704. For example, a television-based client device 710 can initiate a record request to have media content recorded for a scheduled recording or to record and provide a pause buffer for the television-based client device. The recording node 716 can receive the record request and record the media content such that the television-based client device can access and render the recorded media content from the recording node via the DVR system network 714 and/or the communication network 708.

FIG. 8 illustrates various components of an exemplary client device 800 which can be implemented as any form of a computing, electronic, or television-based client device in which embodiments of pre-populated search results in EPG data can be implemented. For example, the client device 800 can be implemented as a television-based client device at a DVR node of the multi-DVR system shown in FIG. 7.

Client device 800 includes one or more media content inputs 802 which may include Internet Protocol (IP) inputs over which streams of media content are received via an IP-based network. Device 800 further includes communication interface(s) 804 which can be implemented as any one or more of a serial and/or parallel interface, a wireless interface, any type of network interface, a modem, and as any other type of communication interface. A wireless interface enables client device 800 to receive control input commands 806 and other information from an input device, such as from remote control device 808, a portable computing-based device (such as a cellular phone) 810, or from another infrared (IR), 802.11, Bluetooth, or similar RF input device.

A network interface provides a connection between the client device 800 and a communication network by which other electronic and computing devices can communicate data with device 800. Similarly, a serial and/or parallel interface provides for data communication directly between client device 800 and the other electronic or computing devices. A modern facilitates client device 800 communication with other electronic and computing devices via a conventional telephone line, a DSL connection, cable, and/or other type of connection.

Client device 800 also includes one or more processors 812 (e.g., any of microprocessors, controllers, and the like) which process various computer executable instructions to control the operation of device 800, to communicate with other electronic and computing devices, and to implement embodiments of multi-DVR node communication. Client device 800 can be implemented with computer readable media 814, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 814 provides data storage mechanisms to store various information and/or data such as software applications and any other types of information and data related to operational aspects of client device 800. For example, an operating system 816 and/or other application programs 818 can be maintained as software applications with the computer readable media 814 and executed on processor(s) 812 to implement embodiments of multi-DVR node communication.

For example, client device 800 can be implemented to include a program guide application 820 that is implemented to process program guide data 822 and generate program guides for display which enable a viewer to navigate through an onscreen display and locate broadcast programs, recorded programs, video on-demand programs and movies, interactive game selections, network-based applications, and other media access information or content of interest to the viewer.

The client device 800 can also include a DVR system 824 with playback application 826, and recording media 828 to maintain recorded media content 830 which may be any form of on-demand and/or media content such as programs, movies, commercials, music, and similar audio, video, and/or image content that client device 800 receives and/or records. Further, client device 800 may access or receive additional recorded media content that is maintained with a remote data store (not shown), such as from a video-on-demand server, or media content that is maintained at a broadcast center or content provider that distributes the media content to subscriber sites and client devices. The playback application 826 is a video control application that can be implemented to control the playback of media content, the recorded media content 830, and or other video on-demand media content, music, and any other audio, video, and/or image media content which can be rendered and/or displayed for viewing.

The client device 800 also includes an audio and/or video output 832 that provides audio and video to an audio rendering and/or display system 834, or to other devices that process, display, and/or otherwise render audio, video, and image data. Video signals and audio signals can be communicated from device 800 to a display device 836 via an RF (radio frequency) link, S-video link, composite video link, component video link, analog audio connection, or other similar communication link. Alternatively, the audio rendering and/or display system 834 is/are integrated components of the exemplary client device 800.

FIG. 9 illustrates an exemplary entertainment and information system 900 in which an IP-based television environment can be implemented, and in which embodiments of pre-populated search results in EPG data can be implemented. System 900 facilitates the distribution of media content, program guide data, and advertising content to multiple viewers and to multiple viewing systems. System 900 includes a content provider 902 and television-based client systems 904(1−N) each configured for communication via an IP-based network 906. Each television-based client system 904(1−N) is an example of the television-based client systems 906(1−N) described with reference to FIG. 7. Each of the television-based client systems 904(1−N) can receive one or more data streams from content provider 902 which are then distributed to one or more other television-based client devices at DVR nodes of a multi-DVR system.

The network 906 can be implemented as a wide area network (e.g., the Internet), an intranet, a Digital Subscriber Line (DSL) network infrastructure, or as a point-to-point coupling infrastructure. Additionally, network 906 can be implemented using any type of network topology and any network communication protocol, and can be represented or otherwise implemented as a combination of two or more networks. A digital network can include various hardwired and/or wireless links 908(1−N), routers, gateways, and so on to facilitate communication between content provider 902 and the client systems 904(1−N). The television-based client systems 904(1−N) receive media content, program content, program guide data, advertising content, closed captions data, and the like from content server(s) of the content provider 902 via the IP-based network 906.

System 900 includes a media server 910 that receives media content from a content source 912, program guide data from a program guide source 914, and advertising content from an advertisement source 916. In an embodiment, the media server 910 represents an acquisition server that receives the audio and video media content from content source 912, an EPG server that receives the program guide data from program guide source 914, and/or an advertising management server that receives the advertising content from the advertisement source 916.

The content source 912, the program guide source 914, and the advertisement source 916 control distribution of the media content, the program guide data, and the advertising content to the media server 910 and/or to other television-based servers. The media content, program guide data, and advertising content is distributed via various transmission media 918, such as satellite transmission, radio frequency transmission, cable transmission, and/or via any number of other wired or wireless transmission media. In this example, media server 910 is shown as an independent component of system 900 that communicates the program content, program guide data, and advertising content to content provider 902. In an alternate implementation, media server 910 can be implemented as a component of content provider 902.

Content provider 902 is representative of a headend service in a television-based content distribution system, for example, that provides the media content, program guide data, and advertising content to multiple subscribers (e.g., the television-based client systems 904(1−N)). The content provider 902 can be implemented as a satellite operator, a network television operator, a cable operator, and the like to control distribution of media content, program and advertising content, such as movies, television programs, commercials, music, and other audio, video, and/or image content to the client systems 904(1−N).

Content provider 902 includes various components to facilitate media data processing and content distribution, such as a subscriber manager 920, a device monitor 922, and a content server 924. The subscriber manager 920 manages subscriber data, and the device monitor 922 monitors the client systems 904(1−N) (e.g., and the subscribers), and maintains monitored client state information.

Although the various managers, servers, and monitors of content provider 902 (to include the media server 910 in one embodiment) are illustrated and described as distributed, independent components of content provider 902, any one or more of the managers, servers, and monitors can be implemented together as a multi-functional component of content provider 902. Additionally, any one or more of the managers, servers, and monitors described with reference to system 900 can implement features and embodiments of multi-DVR node communication.

The television-based client systems 904(1−N) can be implemented to include a television-based client device 926 and a display device 928 (e.g., a television, LCD, and the like). A television-based client device 926 of a television-based client system 904 can be implemented in any number of embodiments, such as a set-top box, a digital video recorder (DVR) and playback system, an appliance device, a gaming system, and as any other type of client device that may be implemented in a television-based entertainment and information system. In an alternate embodiment, client system 904(N) is implemented with a computing device 930 as well as a television-based client device 926. Additionally, any of the television-based client devices 926 of a television-based client system 904 can implement features and embodiments of multi-DVR node communication as described herein.

Although embodiments of pre-populated search results in EPG data have been described in language specific to features and/or methods, it is to be understood that the subject of the appended claims is not necessarily limited to the specific features or methods described. Rather, the specific features and methods are disclosed as exemplary implementations of pre-populated search results in EPG data.

1. A method comprising:
receiving electronic program guide (EPG) data that includes asset information which corresponds to a media content asset, the asset information including descriptor categories; a value associated with at least one of the descriptor categories to describe the media content asset; and a tag that identifies related media content assets which are associated with the value;
receiving a viewer-initiated search request to identify the related media content assets which are associated with the value; and
generating a display of the related media content assets identified by the tag in response to the viewer-initiated search request, the display of the related media content assets being generated from the received EPG data.

2. A method as recited in claim 1, wherein the display of the related media content assets is generated without initiating a request to a content provider to provide the related media content assets.

3. A method as recited in claim 1, further comprising:
initiating a request to a content provider to provide additional related media content assets which are related to the value;
receiving the additional related media content assets from the content provider; and
generating a display of the additional related media content assets.

4. A method as recited in claim 1, wherein the related media content assets are associated with the value based on at least one of: viewer recommendations; viewer requests; associated fees; associated language.

5. A method as recited in claim 1, wherein the related media content assets associated with the value include video-on-demand (VOD) assets.

6. A method as recited in claim 1, wherein the related media content assets associated with the value include video-on-demand (VOD) assets, and wherein the tag also identifies additional data associated with the VOD assets.

7. A method as recited in claim 1, wherein:
the related media content assets associated with the value include video on demand (VOD) assets;
the tag also identifies additional data associated with the VOD assets;
the additional data associated with the VOD assets is initially hidden from view when generating the display of the related media content assets; and wherein
the additional data associated with the VOD assets is displayed in response to receiving a viewer-initiated selection of a VOD asset from the display of the related media content assets.

8. A method comprising:
associating asset information with a media content asset in electronic program guide (EPG) data which can be communicated to a television-based client device, where the associating includes: associating a value with a descriptor category to describe the media content asset; and associating a tag with the value to pre-populate a search result by identifying related media content assets which are related to the value; and
communicating the EPG data that includes the asset information to the television-based client device that can receive a viewer-initiated search request to identify the related media content assets which are associated with the value by the tag, and generate a display of the related media content assets from the EPG data in response to the viewer-initiated search request.

9. A method as recited in claim 8, wherein the related media content assets are associated with the value based on at least one of: viewer recommendations; viewer requests; associated fees; associated language.

10. A method as recited in claim 8, wherein the related media content assets that are associated with the value include video-on-demand (VOD) assets.

11. A method as recited in claim 8, wherein the related media content assets that are associated with the value include video-on-demand (VOD) assets, and wherein the tag also identifies additional data associated with the VOD assets.

12. A method as recited in claim 8, wherein:
the related media content assets associated with the value include video-on-demand (VOD) assets;
the tag also identifies additional data associated with the VOD assets;
the additional data associated with the VOD assets is initially hidden from view when generating the display of the related media content assets; and wherein
the additional data associated with the VOD assets is displayed in response to receiving a viewer-initiated selection of a VOD asset from the display of the related media content assets.

13. A method as recited in claim 8, further comprising:
receiving a request from the television-based client device to provide additional related media content assets which are related to the value; and
communicating the additional related media content assets to the television-based client device.

14. A method as recited in claim 8, further comprising the television-based client device:
receiving the EPG data that includes the asset information;
receiving the viewer-initiated search request to identify the related media content assets which are associated with the value; and
generating the display of the related media content assets from the EPG data.

15. A method as recited in claim 14, wherein the display of the related media content assets is generated at the television-based client device without initiating a request to a content provider to provide the related media content assets.

16. A method as recited in claim 14, further comprising the television-based client device:
initiating a request to a content provider to provide additional related media content assets which are related to the value;
receiving the additional related media content assets from the content provider; and
generating a display of the additional related media content assets.

17. A system comprising:
a content provider configured to associate asset-information with a media content asset in electronic program guide (EPG) data such that a value describing the media content asset is associated with a descriptor category, and a tag is associated with the value to identify related media content assets which are related to the value; and
a television-based client device configured to:
receive the EPG data that includes the asset information from the content provider;
receive a viewer-initiated search request to identify the related media content assets which are associated with the value by the tag; and
generate a display of the related media content assets from the EPG data in response to the viewer-initiated search request.

18. A system as recited in claim 17, wherein the television-based client device is further configured to generate the display of the related media content assets from the EPG data without initiating a request to the content provider to provide the related media content assets.

19. A system as recited in claim 17, wherein the television-based client device is further configured to:
initiate a request to the content provider for additional related media content assets which are related to the value;
receive the additional related media content assets from the content provider; and
generate a display of the additional related media content assets.

20. A system as recited in claim 17, wherein the content provider is further configured to:
receive a request from the television-based client device to provide additional related media content assets which are related to the value; and
communicate the additional related media content assets to the television-based client device.
